(19) United States
(12) Patent Application Publication
(10) Pub. No.: US 2018/0255957 A1
(43) Pub. Date: Sep. 13, 2018

(54) SYSTEM AND METHOD FOR MINIMUM SAFE TEMPERATURE IN COOKING SOUS VIDE

(71) Applicant: Jeff WU, Stafford, TX (US)

(72) Inventor: Jeff WU, Stafford, TX (US)

(21) Appl. No.: 15/761,235

(22) PCT Filed: Sep. 30, 2016
(86) PCT No.: PCT/US16/54945

§ 371 Date: Mar. 19, 2018

Related U.S. Application Data
(60) Provisional application No. 62/235,182, filed on Sep. 30, 2015.

(51) Int. Cl. A47J 27/10; A47J 36/32; A47J 27/21; A47J 27/00; A23L 5/10

(52) U.S. Cl. CPC A47J 27/10; A47J 36/32; A23V 2002/00; A47J 27/004; A23L 5/13; A47J 27/21083

(57) ABSTRACT

A sous vide cooking program for precision cooking. The cooking program automatically lowers the cook temperature to minimum safe temperature after finishing a cooking program so food does not become over cooked and holds system temperature to halt further cooking and to prevent bacteria growth. Program can also start lowering the temperature to cook food on a temperature gradient to accurately achieve desired results via mathematic modeled gradient curves.

### RELATED APPLICATIONS

This application is a 371 of international PCT Application No. PCT/US2016/054945, filed Sep. 30, 2016 which claims the benefit of U.S. Provisional Application No. 62/235,182, entitled SYSTEM AND METHOD FOR MINIMUM SAFE TEMPERATURE IN COOKING SOUS VIDE, filed on Sep. 30, 2015, all of the contents which is incorporated herein by reference in their entirety for all purposes.

### FIELD OF TECHNOLOGY

The present disclosure relates generally to food cooking devices, and more specifically, to precision temperature control water bath heaters and water pumping heating circulator appliance for cooking food in water.

### BACKGROUND

Sous-vide is a method of cooking food in highly precise temperature environment in a water bath for longer than normal cooking times at an accurately regulated temperature much lower than normally used for cooking, typically around 55° C. (113° F.) to 85° C. (185° F.) for meats and higher for vegetables.

Sous vide food is usually held at cooking temperature until served—this can be problematic for people who want to prepare food in the morning to serve for dinner because of over cooking and texture change of the food over time. While not universally known, sous vide food can be over cooked; given enough time, all proteins will denature. Sous vide precision temperature cooking is a slow and controlled denaturation of protein. By changing the temperature/time, and given enough control, the denaturing process slows to a point where food can be cooked in the morning and held at a lower safe temperature until the afternoon ready to be served.

### BRIEF DESCRIPTION OF THE DRAWINGS

In order to describe a manner in which features of the disclosure can be obtained, reference is made to specific embodiments that are illustrated in the appended drawings. Based on an understanding that these drawings depict only example embodiments of the disclosure and are not intended to be limiting of scope, the principles herein are described and explained, wherein:

FIG. 1 is a cross-sectional view illustrating a fluidic temperature control device in accordance with an example embodiment;

FIG. 2 is a cross-sectional view illustrating a fluidic temperature control device in accordance with an example embodiment;

FIG. 3 is a flow chart of a sous-vide controlling program method;

FIG. 4 is a system and/or control unit for a fluidic temperature control device or related electronic device in accordance with an example embodiment; and

FIG. 5 is a block diagram of an electronic device in accordance with an example implementation is illustrated.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without departing from the scope of the disclosure.

Several definitions that apply throughout this document will now be presented. “Circulating” means agitating, blending or mixing of one or more fluids. Hence a “circulator” is a device which can be configured to agitate, blend or mix a fluid. Fluids will be understood to comprise liquids. “Coupled” is defined as connected, whether directly or indirectly through intervening components and is not necessarily limited to physical connections. Coupled devices are devices which are in signal communication with one another. “Connected” means directly connected or indirectly connected. “Microprocessor” can mean one more multiple computing arrays. “Program” refers to imbedded program on the sous vide cooker or programs located on a connected device like phone or computer.

Broadly speaking, this disclosure relates to a sous-vide cookers—either bath, or circulators or other steam or gas devices for sous-vide cooking.

Disclosed are systems and methods for controlling a sous vide cooker. The methods can include determining a cook temperature should be altered, altering the cook temperature, and alerting the cook temperature has been altered. The alert can be an audio or visual alert.

In some examples, the method can also determine a recipe cook time has ended, and in response to the recipe cook time ending, lower the cook temperature to a hold temperature. The hold temperature can be based on a food type.

In some examples, the method can also determine the cook temperature is less than a minimum safe cook temperature, and in response, raise the cook temperature to the minimum safe cook temperature. The minimum safe cook temperature is based on a food type.

In some examples, the method can also detect a power loss, and in response to detecting the power loss can determine a current temperature is equal to or greater than a minimum safe temperature, and maintain the minimum safe temperature.

In some examples, the method can also detect a power loss, in response to detecting the power loss can determine a current temperature is less than a minimum safe temperature, determine a time length of the power loss, and in response to the time length being less than a predetermined time length, modulating to the minimum safe temperature.

In some examples, the method can also detect a power loss, in response to detecting the power loss can determine a current temperature is equal to or greater than a preset temperature safety limits for a food in a water bath, and maintain the preset temperature safety limits.

In some examples, the method can also detect a power loss, in response to detecting the power loss can determine a current temperature is less than a preset temperature safety limit for a food in a water bath, and alert that the food is less thank a preset temperature safety limit.

In some examples, the method can also receive a user input, and alter the cooking temperature based on the user input. The user input can include one of at least a doneness settings, a thickness, a mass, a fat content, or to slow a cook process.

Also disclosed is a sous vide cooker including a controller and a memory storing instructions which when executed by the controller, cause the controller to determine a cook temperature should be altered, alter the cook temperature, and alert the cook temperature has been altered.

In some examples, the instructions can cause the controller to determine a recipe cook time has ended, and in response to the recipe cook time ending, lower the cook temperature to a hold temperature.

In some examples, the instructions can cause the controller to determine the cook temperature is less than a minimum safe cook temperature, and in response, raise the cook temperature to the minimum safe cook temperature.

In some examples, the instructions can cause the controller to detect a power loss, and in response to the detection of the power loss, determine a current temperature is equal to or greater than a minimum safe temperature, and maintain the minimum safe temperature.

In some examples, the instructions can cause the controller to detect a power loss, and in response to the detection of the power loss determine a current temperature is less than a minimum safe temperature, determine a time length of the power loss, and in response to the time length being less than a predetermined time length, modulate to the minimum safe temperature.

In some examples, the instructions can cause the controller to detect a power loss, and in response to the detection of the power loss determine a current temperature is equal to or greater than a preset temperature safety limits for a food in a water bath, and maintain the preset temperature safety limits.

In some examples, the instructions can cause the controller to detect a power loss, and in response to the detection of the power loss determine a current temperature is less than a preset temperature safety limit for a food in a water bath, and alert the food is less thank a preset temperature safety limit.

In some examples, the instructions can cause the controller receive a user input and alter the cooking temperature based on the user input.

In some examples, sous-vide cookers or the devices controlling them can automatically stop cooking at the set temperature (for a recipe) and drop to a lower hold temperature. The lower hold temperature can be similar to a “keep warm” or “simmer” setting in other household appliances. The program can be configured to following recipe instructions or user inputs to cook food, and lower the cooking temperature following completion of these instructions. If a user is unable to remove the food, the system can be configured to drop to a lower hold temperature capable of halting or slowing the cooking process.

In some examples, a sous-vide circulator cooker or the device controlling the cooker can modulate the recipe cook time to account for the length of the hold time.

In some examples, a sous-vide circulator cooker or the device controlling the cooker can cook foods on a gradient and/or step-wise fashion to slowly denature proteins until a specific time. In this arrangement the sous-vide cooker can cook food in a gradient fashion wherein the food is cooked at a first temperature for a first predetermined period of time, then cooked at a second temperature for a second predetermined time. There can be a plurality of cooking temperature steps and cooking temperatures depending on the type of food being cooked and the time input by the user. The gradient can be determined using mathematical gradient curves.

In some examples, the system can, self-restart based on temperature, time, and/or temperature after a power off event. The self-restart can further be based on preset or user determined safety parameters. In some examples, the system can resume gradient control after a loss of power condition is detected and power is restored.

In some examples, the system can include a microprocessor preset with temperature safety limits for certain types of foods. The microprocessor can compare the actual temperature data with the preset safety limits to determine whether the system needs to restart. The food safety temperatures can be programmed to prevent the food from being under cooked, becoming over cooked, and also to maintain a temperature high enough to prevent bacteria growth.

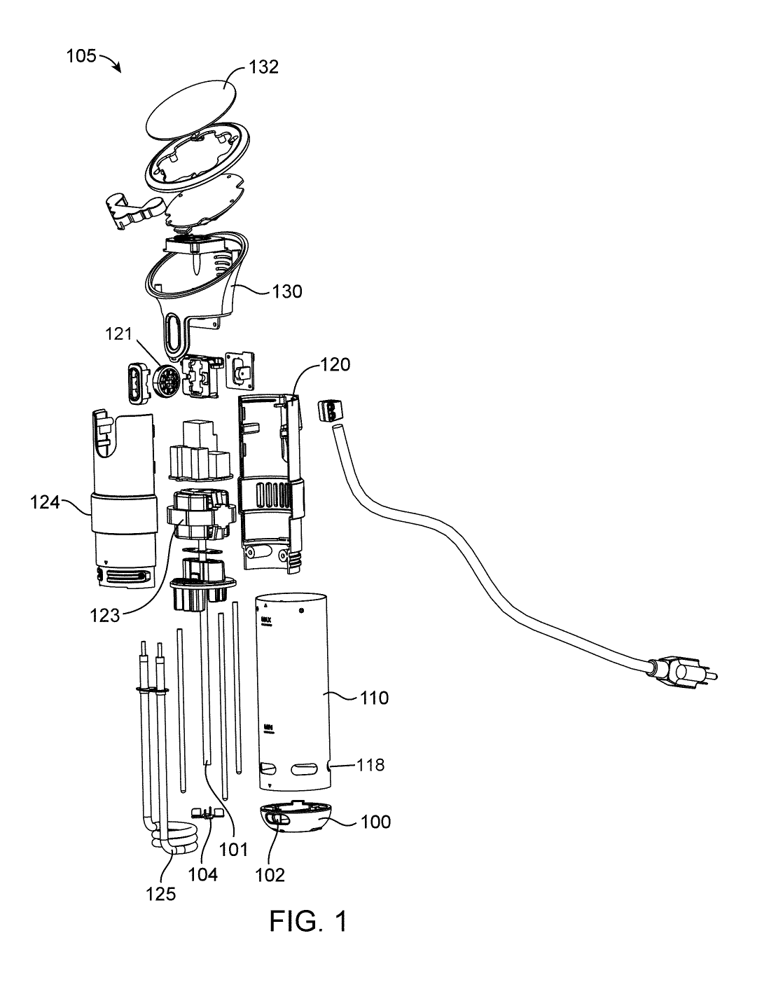

FIG. 1 illustrates components of examples of a fluidic temperature control device 105. In some examples, device 105 can include three portions as illustrated in FIG. 1. In alternate examples fluidic temperature control device 105 can include two portions or one portion (e.g., upper and middle portions can be combined).

The device can include a lower portion 110. The lower portion 110 can be a removable, tool-less screw or clamp-on circulator pump housing or other agitation device housing. Lower portion 110 can include heaters 125, drive shaft 101 and impeller 104. The lower portion 110 can be composed of stainless steel or other suitable materials. In some examples, the lower portion 110 can be a removable clamp-on skirt. The lower portion 110 can be configured with one or more liquid intake (flow-in) openings 118. Alternatively, openings 118 can be liquid output (flow-out) openings. The device 105 can also include a liquid ejection (flow-out) cap 100 with one or more openings 102, on the side or bottom, through which fluid can pass (as liquid intake (flow-in) or liquid output (flow-out)). Middle portion 120 can enclose motor and heater base 123 connected to electric heaters 125. Middle portion 120 can also comprise a fan (not shown) to blow out any steam that may be present. Middle portion 120 can include collar 124 including one or more openings to provide ventilation to motor and heater base 123. The device 105 can also include an upper portion 130. The upper portion 130 can include a LCD display 132 with touch controls. In other embodiments, upper portion 130 can include a separate input device 121 (e.g., a scroll wheel, one or more buttons, etc.). Input device 121 and/or the touch controls of LCD display 132 can be configured to operate device 105 (e.g., set temperature, set time, select settings, etc.). Device 105 can be sealed against water/air and can be fully submersed for periods of time in the cooking container with the fluid being heated by the device.

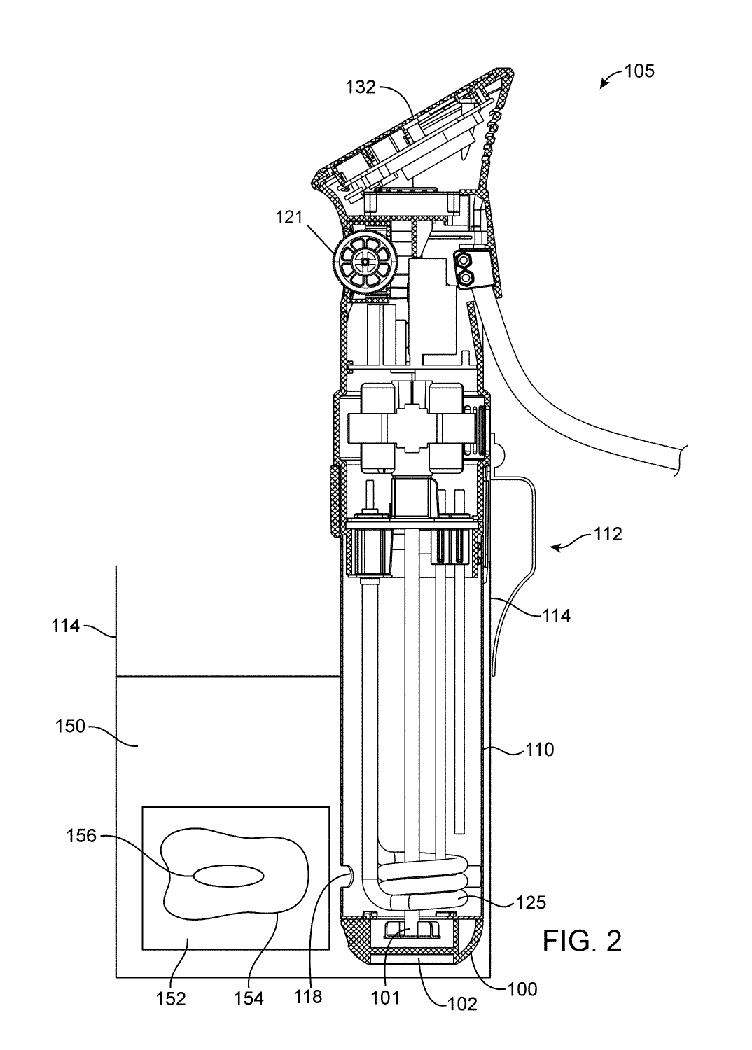

FIG. 2 illustrates an example fluidic temperature control device 105 in communication with a wireless temperature sensor. Device 105 is adjustably attached to container 114 containing fluid 150 (e.g., water). The temperature of fluid 150 can be regulated by device 105, as previously described. The wireless temperature sensor 156 can be placed proximate (or within) the food 154 within a sealed container 152 (e.g., a plastic bag or plastic envelope) located in fluid 150. In some examples, the temperature sensor can be wired to and located at fluidic temperature control device 105. Wireless temperature sensor 156 can connect to and transmit temperature data to device 105. Wireless temperature sensor 156 can connect to and transmit temperature data to an electronic device in communication with device 105.

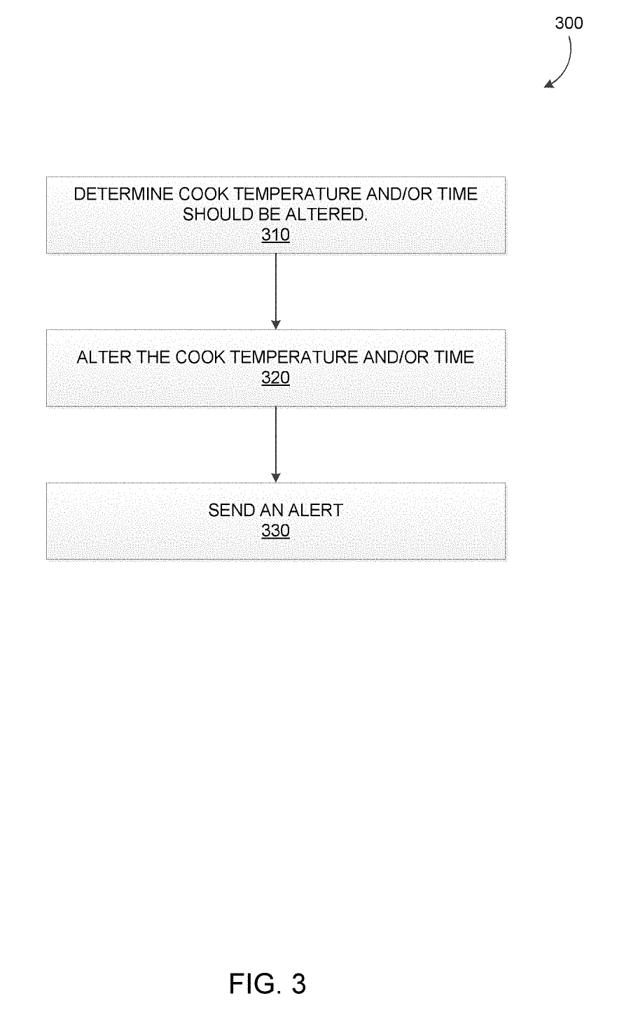

FIG. 3 illustrates a method for controlling a sous-vide cooker within a specific temperature range (e.g., minimum safe temperature, food texture, chemical process, promote bacteria growth, etc.). The method shown in FIG. 3 is provided by way of example, as there are a variety of ways to carry out the method. Additionally, while the example method is illustrated with a particular order of blocks, those of ordinary skill in the art will appreciate that FIG. 3 and the blocks shown therein can be executed in any order that accomplishes the technical advantages of the present disclosure and can include fewer or more blocks than illustrated.

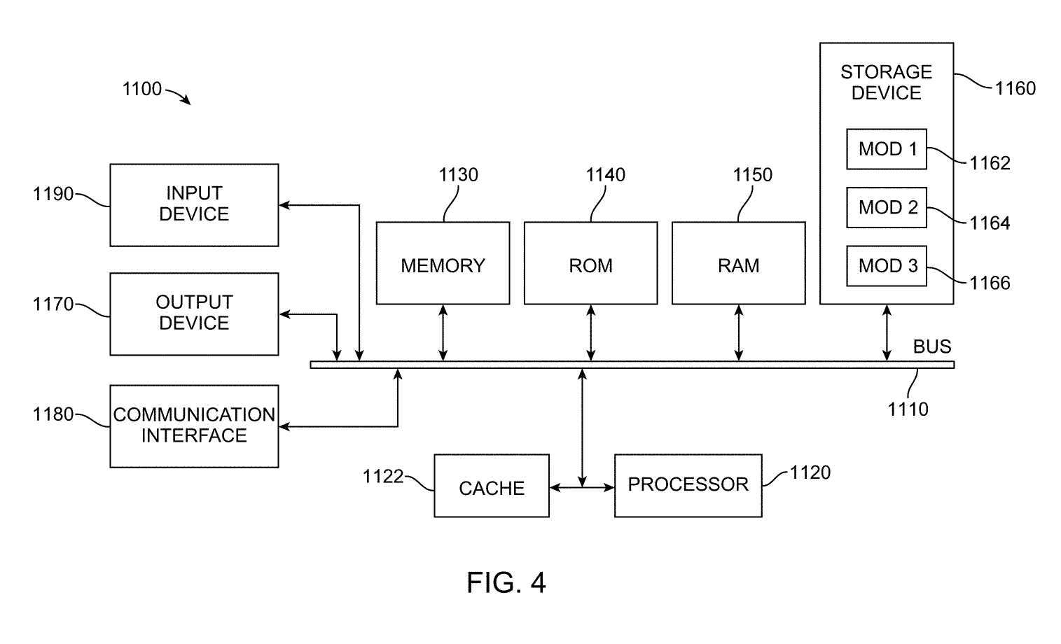

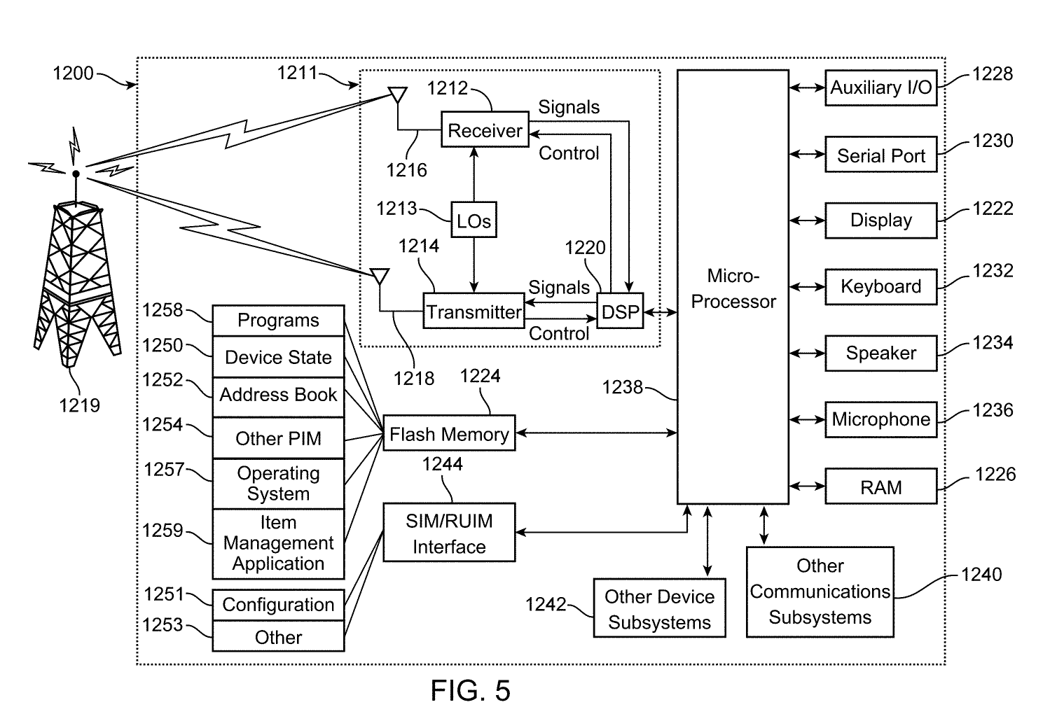

Each block shown in FIG. 3 represents one or more processes, methods or subroutines, carried out in the example method. The blocks shown in FIG. 3 can be implemented in a cooker such as cooker 105 shown in FIG. 1 (or devices in FIG. 4-5). The flow chart illustrated in FIG. 3 will be described in relation to and make reference to at least the elements of system 100 shown in FIG. 1.

Method 300 can begin at block 310. At block 310, the cooker 105 can determine that the cook temperature (and/or time) should be changed (e.g., increased or decreased). For example, cooker 105 can determine to change the temperature of the water bath after a predetermined time based on recipe specifications. The recipe specification can be in relation to the type of food (e.g., meat, vegetable, yogurt, etc.). For example, a recipe specification can have a minimum temperature (e.g., between 45-60 C) to keep already cooked meat(s) above a temperature threshold in order to prevent bacteria growth, while preventing overcooking. The minimum temperature can be determined based on the type of meat (e.g., chicken, beef, pork, etc.). In other examples, a recipe specification can keep vegetables or other types of non-meat consumables at a hold temperature to tenderize and/or prevent changing in texture of the consumables (e.g., the temperature are dependent on the consumables). In other examples, a recipe specification can keep yogurt or other consumables at a temperature (e.g., 37-50 C) for incubation purposes to promote bacteria growth. In other examples, a receipt specification can keep a substance in the water bath at a temperature for either causing or preventing a chemical reaction (i.e., the temperature will be dependent on the substance).

The cooker 105 can also change the cook temperature based on a user input. The input specifications can include doneness settings, thickness, mass, fat content, bacteria growth, chemical reaction, or slowing a cook process.

In some examples, cooker 105 can determine to lower the temperature to a hold temperature to slow the cooking process (e.g., to keep texture of food consistent). The hold temperature can also be within the minimum safe temperature. The hold temperature (e.g., the determination) can be determined based on a natural cooling rate of the water bath. For example, based on the natural cooling rate, the cooker can determine the estimated temperature of the water bath at specific times in the future and activate the hold temperature at the specific time necessary in accordance with the food type. In other examples, the hold temperature can be automatically set after a recipe has finished (e.g., until the user removes the food items).

In some examples, cooker 105 can determine to raise the temperature to a minimum safe temperature (e.g., temperature that food is safe for consumption, prevent bacteria growth, etc.). The minimum safe temperature (e.g., the determination) can be determined based on a natural cooling rate of the water bath as explained above. A memory of cooker 105 can store preset temperature safety limits for certain foods. Alternatively, cooker 105 can access the preset temperature safety limits over a wireless network (e.g., from a server, website, etc.). The preset temperature safety limits are compared to actual temperature data to determine if the food can be kept within a minimum safe temperature.

In some examples, cooker 105 can determine the natural cooling rate (and cooking recipe) on a step-wise temperature drop or gradient temperature drop, and in response can increase (or decrease) the temperature and time to a minimum safe (or hold) temperature.

At block 320, cooker 105 can alter the cooking time and temperature. For example, the cooking time and temperature can be altered (e.g., actuation of heater and/or agitation device) based on the determination in step 310. In some examples, the cooking time and temperature can be altered based on the current recipe settings, user input, or a predetermined time. In some examples, the cooking time and temperature can be altered based on a step-wise temperature drop function (e.g., to avoid the growth of bacteria, etc.). In other examples, the cooking temperature and time can be altered to raise temperature to a minimum safe temperature (e.g., to avoid the growth of bacteria, etc.). In other examples, the cooking temperature and time can be altered to lower temperature to a hold temperature (e.g., to avoid altering the texture of the food, promote bacteria growth, etc.). In some examples, the hold temperature and or/minimum safe temperature can be between 45-60 C. In some examples, the hold temperature and or/minimum safe temperature can be between specific to the consumable type and/or purpose (promote/avoid bacteria growth, texture, safety, chemical reaction, etc.).

At block 330, cooker 105 can notify a user by an alert. For example, when cooker 105 can or cannot achieve desired result (e.g., within a minimum safe temperature). In some examples, an alert can be trigged at the end of a cooking recipe (e.g., upon entrance into a hold temperature). In some examples, an alert can be triggered when the water bath is at a minimum safe temperature. An alert can also be generated at predetermined intervals or upon user configuration. In some examples, the alert can be audio or visually displayed on a speaker and/or display of cooker 105. In other examples, the alert can be sent to an electronic device of the user via a wireless network.

In some examples, cooker 105 can experience a short-term power outage. During the power outage, the water bath will slowly drop in temperature (based on natural cooling laws). When power returns, cooker 105 can determine the current temperature with still within a minimum safe temperature and if the temperature is within a minimum safe temperature, cooker 105 can modulate to a hold temperature and send an alert. In some examples, the system can, self-restart based on temperature, time, and/or temperature after a power off event. The self-restart can further be based on preset or user determined safety parameters. In some examples, the system can resume gradient control after a loss of power condition is detected and power is restored. In some examples, cooker 105 can include a battery for maintaining a minimum safe temperature for a predetermined time period.

FIG. 4 illustrates an example system and/or control unit 1100 of device 105 and/or sensor 156 including a processing unit (for example, a central processing unit (CPU) or processor) 1120 and a system bus 1110 that couples various system components, including the system memory 1130 such as read only memory (ROM) 1140 and random access memory (RAM) 1150, to the processor 1120. The system 1100 can include a cache 1122 of high-speed memory connected directly with, in close proximity to, or integrated as part of the processor 1120. The system 1100 can copy data from the memory 1130 and/or the storage device 1160 to the cache 1122 for access by the processor 1120. These and other modules can control or be configured to control the processor 1120 to perform various operations or actions. The memory 1130 can include multiple different types of memory with different performance characteristics.

Multiple processors or processor cores can share resources such as memory 1130 or the cache 1122, or can operate using independent resources. The processor 1120 can include one or more of a state machine, an application specific integrated circuit (ASIC), or a programmable gate array (PGA) including a field PGA. The system bus 1110 can be any of several types of bus structures including a memory bus or memory controller, a peripheral bus, and a local bus using any of a variety of bus architectures. A basic input/output (BIOS) stored in ROM 1140 or the like, can provide the basic routine that helps to transfer information between elements within the computing device 1100, such as during start-up.

The computing device 1100 can further include storage devices 1160 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. The storage device 1160 can include software modules 1162, 1164, 1166 for controlling the processor 1120. The system 1100 can include other hardware or software modules. Although the exemplary embodiment(s) described herein employs the hard disk as storage device 1160, other types of computer-readable storage devices which can store data that are accessible by a computer, such as magnetic cassettes, flash memory cards, digital versatile disks (DVDs), cartridges, random access memories (RAMs) 1150, read only memory (ROM) 1140, a cable containing a bit stream and the like can also be used in the exemplary operating environment. Tangible computer-readable storage media, computer-readable storage devices, or computer-readable memory devices, expressly exclude media such as transitory waves, energy, carrier signals, electromagnetic waves, and signals per se.

The basic components and appropriate variations can be modified depending on the type of device, such as whether the device 1100 is a small, handheld computing device, a desktop computer, or a computer server. When the processor 1120 executes instructions to perform “operations”, the processor 1120 can perform the operations directly and/or facilitate, direct, or cooperate with another device or component to perform the operations.

To enable user interaction with the computing device 1100, an input device 1190 represents any number of input mechanisms, such as a microphone for speech, a touch-sensitive screen for gesture or graphical input, keyboard, mouse, motion input, scroll wheel, speech and so forth. An output device 1170 can also be one or more of a number of output mechanisms known to those of skill in the art. In some instances, multimodal systems enable a user to provide multiple types of input to communicate with the computing device 1100. The communications interface 1180 generally governs and manages the user input and system output. There is no restriction on operating on any particular hardware arrangement and therefore the basic hardware depicted can easily be substituted for improved hardware or firmware arrangements as they are developed.

One or more parts of the example computing device 1100, up to and including the entire computing device 1100, can be virtualized. For example, a virtual processor can be a software object that executes according to a particular instruction set, even when a physical processor of the same type as the virtual processor is unavailable.

FIG. 5 is a block diagram illustrating an electronic device for controlling a fluidic temperature control device and/or wireless temperature sensor 156. Electronic device 1200 can include fluidic temperature control device 105, a sous-vide cooker, components of a sous-vide cooker, an electronic device used to control device 105, professional electronic devices 375, and/or client electronic devices 350. Electronic device 1200 includes a microprocessor 1238 that controls the operation of the electronic device 1200. A communication subsystem 1211 performs communication transmission and reception with the wireless network 1219. The microprocessor 1238 can be communicatively coupled with an auxiliary input/output (I/O) subsystem 1228 and/or to a serial port (for example, a Universal Serial Bus port) 1230 which can allow for communication with other devices or systems. A display 1222 can be communicatively coupled to microprocessor 1238 to allow for displaying of information to an user of the electronic device 1200. The electronic device 1200 can include a keyboard, 1231, speaker 1234, a microphone, 1236, random access memory (RAM) 1226, and flash memory 1224, all of which can be communicatively coupled to the microprocessor 1238. Other similar components can be provided on the electronic device 1200 as well and optionally communicatively coupled to the microprocessor 1238. Other communication subsystems 1240 and other electronic device subsystems 1242 can be communicatively coupled with the microprocessor 1238. For example, a short range communication system such as BLUETOOTH® communication module or a WI-FI® communication module (a communication module in compliance with IEEE 802.11b). Microprocessor 1238 is configured to perform operating system functions and enables execution of programs on the electronic device 1200. In some implementations not all of the above components can be included in the electronic device 1200. For example, in at least one implementation, the keyboard 1232 is not provided as a separate component and is instead integrated with a touchscreen as described below.

Electronic device 1200 can be equipped with components to enable operation of various programs. In at least one embodiment, flash memory 1224 is enabled to provide a storage location for the operating system 1257, device programs 1258, Address book 1252, PIM 1254 and item management application 1259. The operating system 1257 is generally configured to manage programs 1258 that are also stored in memory 1224 and executable on the microprocessor 1238. The operating system 1257 is configured to service requests made by programs 1258 through predefined program 1258 interfaces. More specifically, the operating system 1257 typically determines the order in which multiple programs 1258 are executed on the microprocessor 1238 and the execution time allotted for each program 1258, manages the sharing of memory 1224 among multiple programs 1258, handles input and output to and from other device subsystems 1242. In addition, users can typically interact directly with the operating system 1257 through a user interface shown on display screen 1222. In at least one embodiment, the operating system 1257 is stored in flash memory 1224; the operating system 1257 in other implementations is stored in read-only memory (ROM) or similar storage element (not shown). As those skilled in the art will appreciate, the operating system 1257, device program 1258 or parts thereof can be loaded in RAM 1226 or other volatile memory.

Electronic device 1200 can be enabled for two-way communication within the wireless communication network 1219. The electronic device 1200 can send and receive signals from a mobile communication service. Examples of communication systems enabled for two-way communication include, but are not limited to, the General Packet Radio Service (GPRS) network, the Universal Mobile Telecommunication Service (UMTS) network, the Enhanced Data for Global Evolution (EDGE) network, the Code Division Multiple Access (CDMA) network, High-Speed Packet Access (HSPA) networks, Universal Mobile Telecommunication Service Time Division Duplexing (UMTS-TDD), Ultra Mobile Broadband (UMB) networks, Worldwide Interoperability for Microwave Access (WiMAX), and other networks that can be used for data and voice, or just data or voice. For the systems listed above, the electronic device 1200 can use a unique identifier to enable the electronic device 1200 to transmit and receive signals from the communication network 1219. Other systems can operate without such identifying information. GPRS, UMTS, and EDGE use a smart card such as a Subscriber Identity Module (SIM) in order to allow communication with the communication network 1219. Likewise, most CDMA systems use a Removable User Identity Module (RUIM) in order to communicate with the CDMA network. A smart card can be used in multiple different electronic devices 1200. The electronic device 1200 can perform some operations without a smart card, but the electronic device 1200 cannot be able to communicate with the network 1219. A smart card interface 1244 located within the electronic device 1200 can enable the removal or insertion of a smart card (not shown). The smart card features memory and holds key configurations 1251, and other information 1253 such as identification and subscriber related information.

Electronic device 1200 can be enabled to both transmit and receive information from the communication network 1219. In order to enable communication with the network 1219, the electronic device 1200 can be equipped with an integral or internal antenna 1218 for transmitting signals to the communication network 1219. Electronic device 1200 can be equipped with antenna 1216 for receiving communication from the communication network 1219. Antennas (1216, 1218) in some examples can be combined into a single antenna. As one skilled in the art would appreciate, the antenna or antennae (1216, 1218) in another implementation are externally mounted on the electronic device 1200.

Communication subsystem 1211 can be configured to support the operational needs of the electronic device 1200. The subsystem 1211 includes a transmitter 1214 and receiver 1212 including the associated antenna or antennae (1216, 1218) as described above, local oscillators (LOs) 1213, and a processing module 1220 for example a digital signal processor (DSP).

Communication between the electronic device 1200 and wireless network 1219 can be any type of communication that both the wireless network 1219 and electronic device 1200 are enabled to transmit, receive and process. In general, the communication can be classified as voice and data. Voice communication generally refers to communication in which signals for audible sounds are transmitted by the electronic device 1200 through the communication network 1219. Data generally refers to all other types of communication that the electronic device 1200 is capable of performing within the constraints of the wireless network 1219.

The keyboard 1232 can include a plurality of keys that can be physical buttons or the plurality of keys can be of a software nature, typically constituted by virtual representations of physical keys on the display screen 1222 (referred to herein as “virtual keys”). The user input can be provided as a combination of the two types of keys. Each key of the plurality of keys can have at least one action which can be the input of indicia such as a character, a command or a function. “Characters” are contemplated to exemplarily include alphabetic letters, language symbols, numbers, punctuation, insignias, icons, pictures, and even a blank space.

In the case of virtual keys, the indicia for the respective keys are shown on the display screen 1222, which in one implementation is enabled by touching the display screen 1222, for example, with a stylus, finger, or other pointer, to generate the character or activate the indicated command or function. Some examples of display screens 1222 capable of detecting a touch include resistive, capacitive, projected capacitive, infrared and surface acoustic wave (SAW) touchscreens.

Physical and virtual keys can be combined in many different ways as appreciated by those skilled in the art. In one implementation, physical and virtual keys are combined such that the plurality of enabled keys for a particular program or feature of the electronic device 1200 is shown on the display screen 1222 in the same configuration as the physical keys. Using the configuration just described, the operator can select the appropriate physical key corresponding to what is shown on the display screen 1222. Thus, the desired character, command or function is obtained by depressing the physical key corresponding to the character, command or function displayed at a corresponding position on the display screen 1222, rather than touching the display screen 1222.

While the above description generally describes the systems and components associated with a handheld electronic device, the electronic device 1200 could be another electronic device such as a PDA, a laptop computer, desktop computer, a server, or other electronic device. The electronic device 1200 can comprise different components or the above system might be omitted in order to provide the desired electronic device 1200. Additionally, other components not described above can be used to allow the electronic device 1200 to function in a desired fashion. The above description provides only general components and additional components can be used to enable the system to function. The additional systems and components would be appreciated by those of ordinary skill in the art

The term “comprising”, which is synonymous with “including,” “containing,” or “characterized by” is inclusive or open-ended and does not exclude additional, unrecited elements or method steps. “Comprising” is a term of art used in claim language which means that the named elements are present, but other elements can be added and still form a construct or method within the scope of the claim.

As discussed above, the various embodiments can be implemented in a wide variety of operating environments, which in some cases can include one or more user computers, computing devices, or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Various aspects also can be implemented as part of at least one service or Web service, such as can be part of a service-oriented architecture. Services such as Web services can communicate using any appropriate type of messaging, such as by using messages in extensible markup language (XML) format and exchanged using an appropriate protocol such as SOAP (derived from the “Simple Object Access Protocol”). Processes provided or executed by such services can be written in any appropriate language, such as the Web Services Description Language (WSDL). Using a language such as WSDL allows for functionality such as the automated generation of client-side code in various SOAP frameworks.

Most embodiments utilize at least one network that would be familiar to those skilled in the art for supporting communications using any of a variety of commercially-available protocols, such as TCP/IP, OSI, FTP, UPnP, NFS, CIFS, and AppleTalk™. The network can be, for example, a local area network, a wide-area network, a virtual private network, the Internet, an intranet, an extranet, a public switched telephone network, an infrared network, a wireless network, and any suitable combination thereof.

In embodiments utilizing a Web server, the Web server can run any of a variety of server or mid-tier applications, including HTTP servers, FTP servers, CGI servers, data servers, Java servers, and business application servers. The server(s) also can be capable of executing programs or scripts in response requests from user devices, such as by executing one or more Web applications that can be implemented as one or more scripts or programs written in any programming language, such as Java®, C, C# or C++, or any scripting language, such as Perl, Python, or TCL, as well as combinations thereof. The server(s) can also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information can reside in a storage-area network (“SAN”) familiar to those skilled in the art. Similarly, any necessary files for performing the functions attributed to the computers, servers, or other network devices can be stored locally and/or remotely, as appropriate. Where a system includes computerized devices, each such device can include hardware elements that can be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system can also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments can have numerous variations from that described above. For example, customized hardware might also be used and/or particular elements might be implemented in hardware, software (including portable software, such as applets), or both. Further, connection to other computing devices such as network input/output devices can be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by a system device.

Embodiments of the present disclosure can be provided as a computer program product including a non-transitory machine-readable storage medium having stored thereon instructions (in compressed or uncompressed form) that can be used to program a computer (or other electronic device) to perform processes or methods described herein. The machine-readable storage medium can include, but is not limited to, hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or other types of media/machine-readable medium suitable for storing electronic instructions. Further, embodiments can also be provided as a computer program product including a transitory machine-readable signal (in compressed or uncompressed form). Examples of machine-readable signals, whether modulated using a carrier or not, include, but are not limited to, signals that a computer system or machine hosting or running a computer program can be configured to access, including signals downloaded through the Internet or other networks. For example, distribution of software can be via Internet download.

Based on the disclosure and teachings provided herein, it will be understood that other ways and methods of implementing the various embodiments described above are possible. The specification and drawings are illustrative and are not to be construed as limiting the scope of the following claims.

1. A method for controlling a sous vide cooker comprising:
determining, at a sous vide cooker, a cook temperature should be altered;
altering, at the sous vide cooker, the cook temperature; and
alerting, from the sous vide cooker, the cook temperature has been altered.

2. The method of claim 1, wherein the determining of the cook temperature further comprises:
determining a recipe cook time has ended; and
in response to the recipe cook time ending, lower the cook temperature to a hold temperature.

3. The method of claim 2, wherein the hold temperature is based on a food type.

4. The method of claim 1, wherein the determining of the cook temperature further comprises:
determining the cook temperature is less than a minimum safe cook temperature; and
in response, raise the cook temperature to the minimum safe cook temperature.

5. The method of claim 4, wherein the minimum safe cook temperature is based on a food type.

6. The method of claim 1, wherein the determining of the cook temperature further comprises:
detecting a power loss; and
in response to detecting the power loss:
determining a current temperature is equal to or greater than a minimum safe temperature; and
maintaining the minimum safe temperature.

7. The method of claim 1, wherein the determining of the cook temperature further comprises:
detecting a power loss; and
in response to detecting the power loss:
determining a current temperature is less than a minimum safe temperature;
determining a time length of the power loss, and
in response to the time length being less than a predetermined time length, modulating to the minimum safe temperature.

8. The method of claim 1, wherein the determining of the cook temperature further comprises:
detecting a power loss; and
in response to detecting the power loss:
determining a current temperature is equal to or greater than a preset temperature safety limits for a food in a water bath; and
maintaining the preset temperature safety limits.

9. The method of claim 1, wherein the determining of the cook temperature further comprises:
detecting a power loss; and
in response to detecting the power loss:
determining a current temperature is less than a preset temperature safety limit for a food in a water bath; and
alerting, from the sous vide cooker, the food is less thank a preset temperature safety limit.

10. The method of claim 1, wherein the determining of the cook temperature further comprises:
receiving, at the sous vide cooker, a user input; and
altering the cooking temperature based on the user input.

11. The method of claim 10, wherein the user input comprises one of at least a doneness settings, a thickness, a mass, a fat content, or to slow a cook process.

12. The method of claim 1, wherein the alert is an audio or visual alert.

13. A sous vide cooker comprising:
a controller; and
a memory storing instructions which when executed by the controller, cause the controller to:
determine a cook temperature should be altered;
alter the cook temperature; and
alert the cook temperature has been altered.

14. The cooker of claim 13, further comprising instructions which cause the controller to:
determine a recipe cook time has ended; and
in response to the recipe cook time ending, lower the cook temperature to a hold temperature.

15. The cooker of claim 13, further comprising instructions which cause the controller to:
determine the cook temperature is less than a minimum safe cook temperature; and
in response, raise the cook temperature to the minimum safe cook temperature.

16. The cooker of claim 13, further comprising instructions which cause the controller to:
detect a power loss; and
in response to the detection of the power loss:
determine a current temperature is equal to or greater than a minimum safe temperature; and
maintain the minimum safe temperature.

17. The cooker of claim 13, further comprising instructions which cause the controller to:
detect a power loss; and
in response to the detection of the power loss:
determine a current temperature is less than a minimum safe temperature;
determine a time length of the power loss, and
in response to the time length being less than a predetermined time length, modulate to the minimum safe temperature.

18. The cooker of claim 13, further comprising instructions which cause the controller to:
detect a power loss; and
in response to the detection of the power loss:
determine a current temperature is equal to or greater than a preset temperature safety limits for a food in a water bath; and
maintain the preset temperature safety limits.

19. The cooker of claim 13, further comprising instructions which cause the controller to:
detect a power loss; and
in response to the detection of the power loss:
determine a current temperature is less than a preset temperature safety limit for a food in a water bath; and
alert the food is less thank a preset temperature safety limit.

20. The cooker of claim 13, further comprising instructions which cause the controller to:
receive a user input; and
alter the cooking temperature based on the user input.
